(19) United States
(12) Patent Application Publication
(10) Pub. No.: US 2025/0374186 A1
(43) Pub. Date: Dec. 4, 2025

(54) Cell wake-up signal or receiver

(71) Applicant: Fraunhofer-Gesellschaft zur Förderung der angewandten Forschung e.V., München (DE)

(72) Inventors: Gustavo Wagner OLIVEIRA DA COSTA, Erlangen (DE); Dariush MOHAMMAD SOLEYMANI, Erlangen (DE); Martin LEYH, Erlangen (DE); Elke ROTH-MANDUTZ, Erlangen (DE); Mehdi HAROUNABADI, Erlangen (DE); Dietmar LIPKA, Erlangen (DE)

(73) Assignee: Fraunhofer-Gesellschaft zur Förderung der angewandten Forschung e.V., München (DE)

(21) Appl. No.: 18/640,925

(22) Filed: Apr. 19, 2024

Related U.S. Application Data
(63) Continuation of application No. PCT/EP2022/078941, filed on Oct. 18, 2022.

(30) Foreign Application Priority Data
Oct. 19, 2021 (EP) 21203531.5

(51) Int. Cl. H04W 52/02; H04L 5/00

(52) U.S. Cl. CPC H04W 52/0235; H04L 5/0005

(57) ABSTRACT

Embodiments provide a transceiver for a wireless communication system, wherein the transceiver is configured to receive a control information describing at least one out of
at least one parameter of a wake-up signal,
at least one low-power operating parameter of a central transceiver of the wireless communication network, and
a list of one or more central transceivers that are in range of the transceiver, wherein the transceiver is configured to transmit, depending on the received control information, a wake-up signal.

### CROSS-REFERENCE TO RELATED APPLICATIONS

This application is a continuation of copending International Application No. PCT/EP2022/078941, filed Oct. 18, 2022, which is incorporated herein by reference in its entirety, and additionally claims priority from European Application No. EP 21203531.5, filed Oct. 19, 2021, which is incorporated herein by reference in its entirety.

Embodiments of the present application relate to the field of wireless communication, and more specifically, to a cell wake-up signal or receiver.

### BACKGROUND

FIG. 1A and FIG. 1B are schematic representations of an example of a terrestrial wireless network 100 including, as is shown in FIG. 1A, a core network 102 and one or more radio access networks RAN1, RAN2, . . . . RANN. FIG. 1B is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANn may include more or less such cells, and RANn may also include only one base station. FIG. 1B shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1B shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1B by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1B by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1A and FIG. 1B may by a heterogeneous network having distinct overlaid networks, e.g., a network of macro cells with each macro cell including a macro base station, like base station gNB1 to gNB5, and a network of small cell base stations (not shown in FIG. 1A and FIG. 1B), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1A and FIG. 1B, for example in accordance with the LTE-Advanced Pro standard or the NR (5G), new radio, standard.

In mobile communication networks, for example in a network like that described above with reference to FIG. 1A and FIG. 1B, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1B. This is referred to as an “in-coverage” scenario. Another scenario is referred to as an “out-of-coverage” scenario. It is noted that “out-of-coverage” does not mean that the two UEs are not within one of the cells depicted in FIG. 1B, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1B. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e., connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1B. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a communication system as described above, the power consumption of mobile networks is a major source of operator OPEX and a large concern for the environment

[symbol]

In order to reduce power consumption, and therefore CO2 emissions, wireless networks need to power down access nodes (e.g., gNB, base stations, and access points) or place them on sleep mode/standby.

To re-activate those access nodes a wake-up signal is used. The solutions to wake up cells can be broadly categorized into:
Autonomous solutions, according to which a cell wakes up based on local decisions (e.g., measurements, heuristics, schedule) which are completely independent from other nodes (e.g., UE, other cells, core network).
Network based solutions, according to which communication and decision takes place within the network to wake up the cells.
Wake-up signals or request, wherein the UE assists the network by actively requesting a cell to wake it up.

An example of autonomous solution is equipping a cell with a low-power sniffer which can measure the uplink of another layer (macrolayer). When a significant increase in noise floor is measured, this is considered as a way of detecting a UE is nearby and the cell turns itself on. Another example of autonomous solution is a device programmed to be turned on during day and turned off during the night.

Network based solutions are often considered for network energy saving. They can be further sub-categorized as centralized or distributed. A common pattern in heterogeneous networks is to have a macrocell layer assisting in waking up cells from a pico/femto layer.

The main advantage of network-based solutions is to have the complete implementation on the network side. Thus, solutions may be compatible with legacy UEs and centralized algorithms taking into account the network state across a multitude of nodes. The main disadvantage is the difficulty in knowing which cells to wake up. This can be to a certain extent tackled by the usage of precise positioning, but that comes at the cost of UE power consumption and extra signaling. A simpler and more robust approach would be to combine network-based methods, e.g., for the long term changes while tracking short term changes with wake-up signal approach.

If the UE actively requests nearby cells to wake-up by sending a wake-up signal it is much easier to define which cells are most suitable to serve the UE. This is described in [1] as the coverage can follow the UE when it moves around. In fact, a macrocell layer is not even needed, or the UE can start the wake-up signal if it finds itself on a macrocell coverage hole. The transmission of wake-up signals is the approach taken by this invention. The specific solution is much more sophisticated than with general approaches, and that should keep the main advantages while circumventing the disadvantages.

The literature on wake-up signals and wake-up receivers is much vaster on the UE side. Also, the wireless communication standards support a number of features to save UE power. Most prominently, the UE can turn off its transceiver for extended periods of time, a technique known as Discontinuous reception (DRX). Depending on the mode a UE in DRX wakes up only to decode the paging channel, which allows it to be re-activated. In the process of reading the paging channel, the UE needs to read synchronization channels and decode control information.

More recently, and particularly motivated by UEs with extreme power limitation (IoT), there is more interest of using wake-up signals and wake-up receivers. Depending on the design of a wake-up signal (or conversely a go-to-sleep signal), the whole process synchronization and/or control information may be skipped if there is no new traffic (no paging). This brings further power saving.

The wake-up signal may be based on existing signals and receiver characteristics like it was defined for 5G NR Release 16 on the UE side. But it is also possible to define wake-up signals which can be more easily detected by dedicated low power wake up receivers. Wake up receivers were standardized for WiFi stations on 802.11ba.

The possibility of using a wake-up signal on the network side is described, but at the cost of having higher power consumption than the network-based solution because the cell transceiver is on all the time. In light of the recent advances on wake-up signals and wake-up receivers on the UE side and considering the specificities of the problem on the network side this invention proposes solutions to use a wake-up signal and receivers on the network side overcoming the limitations perceived in the literature. The goal is to achieve lower activation latency and less complexity than network-based solutions, while potentially also attaining even better power-saving characteristics.

Starting from the above, there is the need for improving the re-activation procedure of access nodes, which are in a low-power mode.

It is noted that the information in the above section is only for enhancing the understanding of the background of the invention and therefore it may contain information that does not form conventional technology and is already known to a person of ordinary skill in the art.

### SUMMARY

An embodiment relates to a transceiver for a wireless communication system, wherein the transceiver is configured to receive a control information describing at least one parameter of a wake-up signal, and at least one low-power operating parameter of a central transceiver of the wireless communication system, wherein the transceiver is configured to transmit, depending on the received control information, a wake-up signal to restore a regular Synchronization Signal Block (SSB) interval of the central transceiver.

Another embodiment relates to a central transceiver of a wireless communication system, wherein the central transceiver is configured to transmit a control information describing at least one parameter of a wake-up signal, and at least one low-power operating parameter of the central transceiver or of another central transceiver of the wireless communication network, wherein the central transceiver is configured to restore a regular Synchronization Signal Block (SSB) interval in response to receiving the wake-up signal.

According to another embodiment, a method for operating a transceiver of a wireless communication network may have the steps of: receiving a control information describing at least one parameter of a wake-up signal, and at least one low-power operating parameter of a central transceiver of the wireless communication network, transmitting, in dependence on the received control information, a wake-up signal to restore a regular Synchronization Signal Block (SSB) interval of the central transceiver.

According to another embodiment, a method for operating a central transceiver of a wireless communication system may have the steps of: transmitting a control information describing at least one parameter of a wake-up signal, and at least one low-power operating parameter of the central transceiver or of another central transceiver of the wireless communication network restoring a regular Synchronization Signal Block (SSB) interval in response to receiving the wake-up signal.

Another embodiment may have a non-transitory digital storage medium having a computer program stored thereon to perform any of the inventive methods when said computer program is run by a computer.

### BRIEF DESCRIPTION OF THE DRAWINGS

Embodiments of the present invention will be detailed subsequently referring to the appended drawings, in which:

FIG. 1A is a schematic representation of an example of a wireless communication system;

FIG. 1B is a schematic representation of an example of a radio access network RANn;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs, according to an embodiment;

FIG. 7 shows an illustrative view of a method of informing a UE about a central transceiver that is in a dormant state and transmitting a wake-up signal to said central transceiver from the UE; and

FIG. 8 illustrates an example of a computer system on which units or modules as well as the steps of the methods described in accordance with the inventive approach may execute.

### DETAILED DESCRIPTION

Equal or equivalent elements or elements with equal or equivalent functionality are denoted in the following description by equal or equivalent reference numerals.

In the following description, a plurality of details are set forth to provide a more thorough explanation of embodiments of the present disclosure. However, it will be apparent to one skilled in the art that embodiments of the present disclosure may be practiced without these specific details. In other instances, well-known structures and devices are shown in block diagram form rather than in detail in order to avoid obscuring embodiments of the present disclosure. In addition, features of the different embodiments described hereinafter may be combined with each other, unless specifically noted otherwise.

As already indicated above, in a communication system as described above, in order to reduce power consumption, and therefore CO2 emissions, wireless networks need to power down access nodes (e.g., gNB, base stations, and access points) or place them on sleep mode/standby. Once such nodes are not regularly transmitting certain signals (e.g., broadcast information, beacons, and reference signals) nor regularly receiving other certain signals (e.g., scheduling requests, buffer status updates, random access) it is particularly hard for the network to determine which users could be served by the dormant cell. Also, if these users which could be served by the dormant cell have a surge of traffic demand, the network will not be timely ready to address the QoS needs of such users.

As a consequence of this lack of knowledge of which cells can remain in the dormant mode and which ones should be made ready for operation the network needs to be quite conservative in powering down the nodes, and therefore only limited power saving is possible.

Embodiments of the present disclosure enable to precisely and timely activate the wireless infrastructure. This allows meeting the needed QoS and at the same time maximize the so important network energy savings.

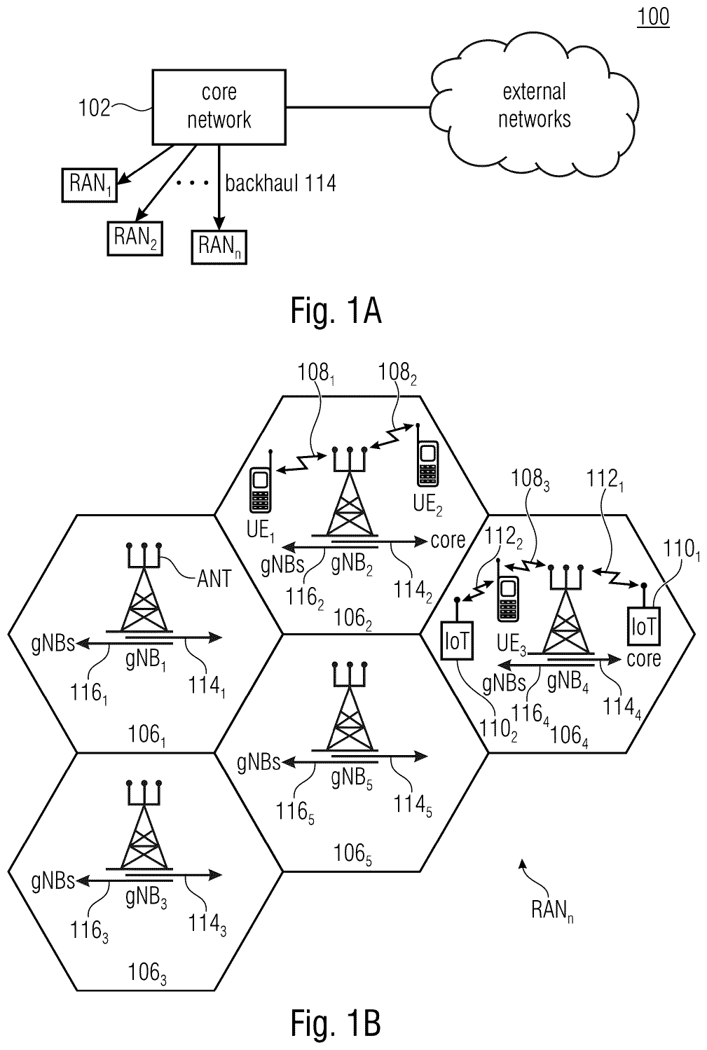

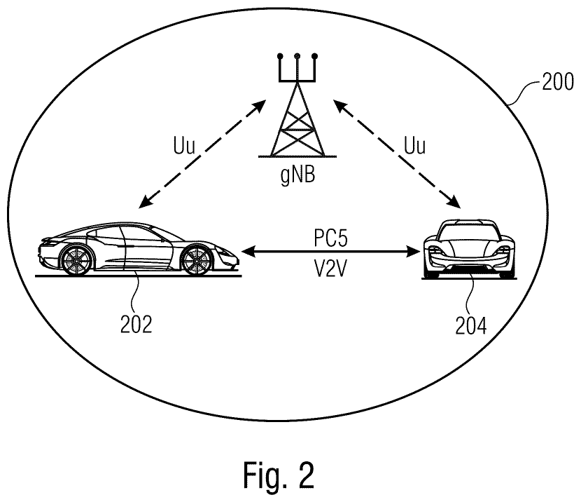

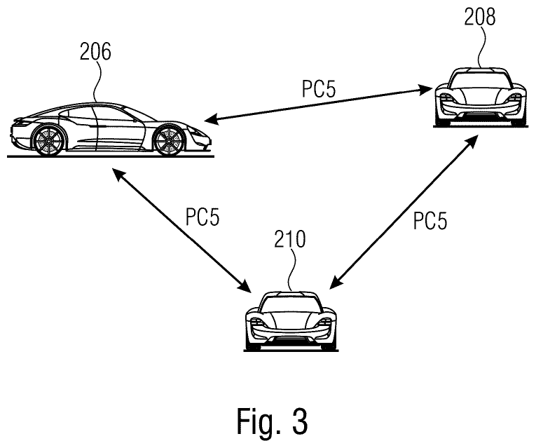

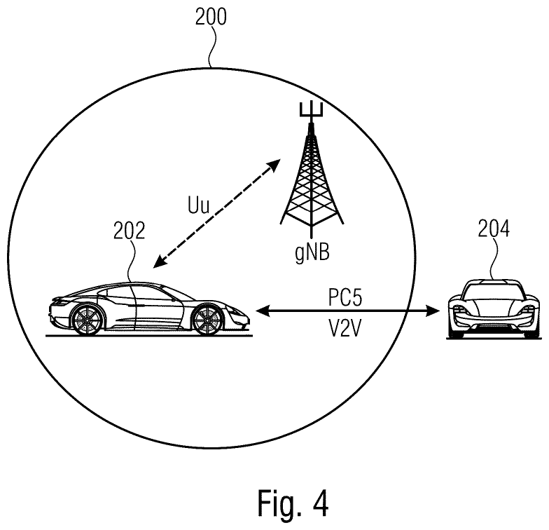

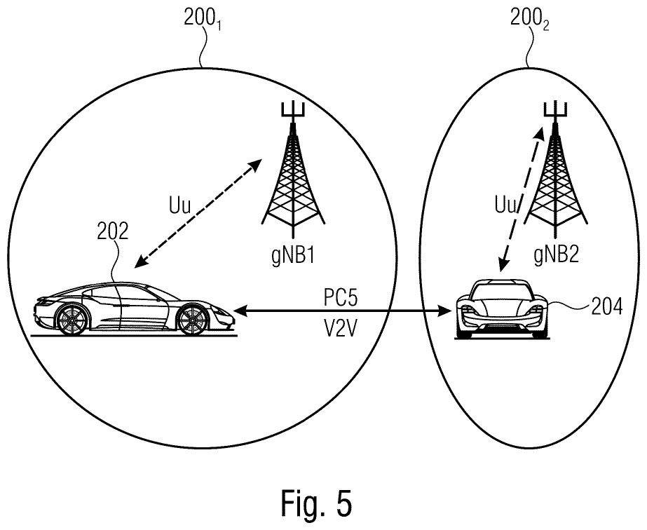

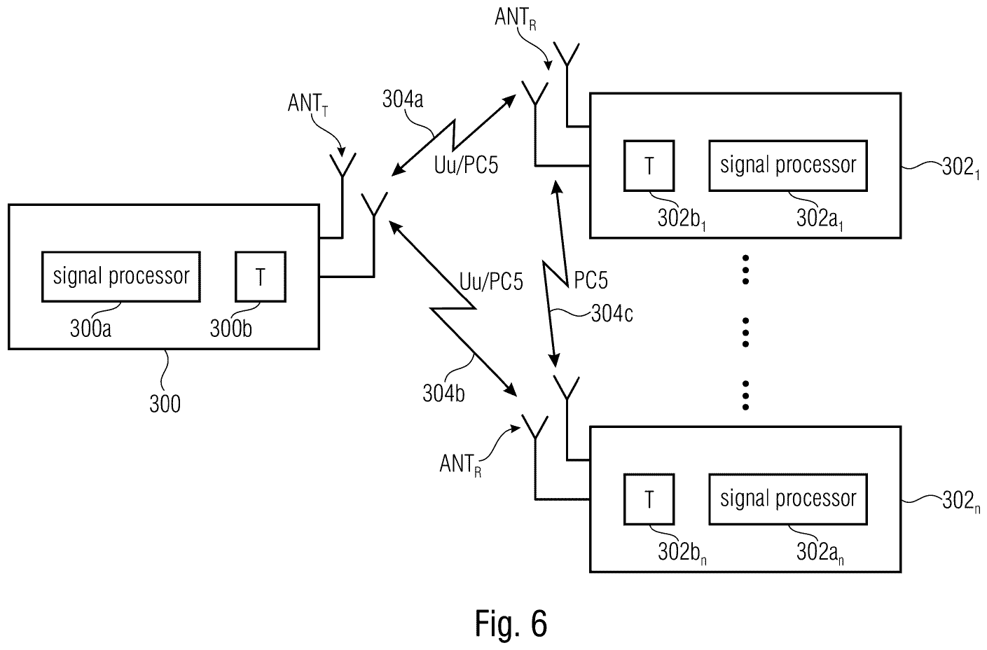

Embodiments of the present disclosure may be implemented in a wireless communication system as depicted in FIGS. 1-5 including base stations and users, like mobile terminals or IoT devices. FIG. 6 is a schematic representation of a wireless communication system including a central transceiver, like a base station, and one or more transceivers 302₁ to 302ₙ, like user devices, UEs. The central transceiver 300 and the transceivers 302 may communicate via one or more wireless communication links or channels 304a, 304b, 304c, like a radio link. The central transceiver 300 may include one or more antennas ANTT or an antenna array having a plurality of antenna elements, a signal processor 300a and a transceiver unit 300b, coupled with each other. The transceivers 302 include one or more antennas ANTR or an antenna array having a plurality of antennas, a signal processor 302a₁, 302aₙ, and a transceiver unit 302b₁, 302bₙ, coupled with each other. The base station 300 and the UEs 302 may communicate via respective first wireless communication links 304a and 304b, like a radio link using the Uu interface, while the UEs 302 may communicate with each other via a second wireless communication link 304c, like a radio link using the PC5 interface. When the UEs are not served by the base station, are not be connected to a base station, for example, they are not in an RRC connected state, or, more generally, when no SL resource allocation configuration or assistance is provided by a base station, the UEs may communicate with each other over the sidelink. The system, the one or more UEs and the base stations may operate in accordance with the inventive teachings described herein.

Embodiments provide a transceiver [e.g., UE] of a wireless communication network, wherein the transceiver is configured to transmit a wake-up signal [e.g., to a central transceiver of the wireless communication network that is currently in a low-power state [e.g., dormant state]].

In embodiments, the transceiver is configured to receive a control information describing at least one out of
at least one parameter of a wake-up signal [e.g., to be used by the transceiver for waking-up a central transceiver of the wireless communication network that is in a low-power state [e.g., dormant state]],
at least one low-power operating parameter of a central transceiver [e.g., gNB, cell, eNB, nB, base station, access point, relay node] of the wireless communication network [e.g., serving a cell in which the transceiver is located or serving a neighboring cell],
a list of one or more central transceivers that are in range of the transceiver [e.g., a list of one or more central transceivers serving the cell in which the transceiver is located and/or serving one or more neighboring cells].

In embodiments, the transceiver is configured to transmit the wake-up signal in dependence on the received control information.

In embodiments, the at least one low-power operating parameter of the central transceiver described by the control information is
a low-power operating state or low-power operating states supported by the central transceiver,
a current low-power operating state of the central transceiver [e.g., dormant or awake],
a time-to-sleep indicator, or
a time-to-wakeup indicator.

In embodiments, the transceiver is configured to receive the control information from
a central transceiver serving a cell in which the transceiver is currently located,
a central transceiver currently serving the transceiver,
another central transceiver [e.g., serving a neighboring cell],
the wireless communication network.

In embodiments, the transceiver is configured to transmit a control information request [e.g., to a central transceiver, macrocell, etc.] requesting the transmission of the control information, wherein the transceiver is configured to receive the control information that is transmitted in response to the control information request.

In embodiments, the transceiver is configured to authenticate itself to a network entity [e.g., AMF or AS] or to log in into the network entity, wherein the wherein the transceiver is configured to receive the control information in response to the successful authentication or logging in.

In embodiments, the transceiver is configured to generate and/or maintain a data base having stored a list of central transceivers together with an information describing a [e.g., geographical] position or area served by each of the central transceivers, wherein the transceiver is configured to select, in dependence on a current [e.g., geographical] position of the transceiver, one out of the central transceivers and to transmit a wake-up signal to the selected central transceiver.

In embodiments, the transceiver is configured to update the data base in dependence on an user input.

In embodiments, the transceiver is configured to transmit a predefined [e.g., standardized] wake-up signal.

In embodiments, the control information describing one or more central transceivers that are in range of the transceiver is a list
of central transceivers serving the cell in which the transceiver is located, and/or
of central transceiver serving neighboring cells.

In embodiments, the at least one parameter of the wake-up signal is
a transmission time or time slot of the wake-up signal,
a transmission frequency or channel of the wake-up signal,
a bandwidth of the wake-up signal,
a waveform type of the wake-up signal,
a time pattern of the wake-up signal,
a code of the wake-up signal,
a sequence of the wake-up, or
a content of the wake-up signal.

In embodiments, the at least one parameter of the wake-up signal is transmitted by
a central transceiver serving a cell in which the transceiver is currently located,
a central transceiver currently serving the transceiver,
another central transceiver [e.g., serving a neighboring cell],
the wireless communication network.

In embodiments, the transceiver is configured to transmit the wake-up signal on a predefined channel [e.g., standard rendezvous channel].

In embodiments, the transceiver is configured to transmit the wake-up signal using a predefined waveform [e.g., OOK, or based on a PN sequence or Zadoff-Chu sequence].

In embodiments, the transceiver is configured to transmit a first wake-up signal to a central transceiver, in order to control the central transceiver to switch from a low-power operating state into a partial low-power operating state, wherein the transceiver is configured to transmit a second wake-up signal to the central transceiver, in order to control the central transceiver to switch from the partial low-power operating state into the normal operating state.

In embodiments, the transceiver is configured to repeatedly transmit a wake-up signal to one or more central transceivers of the wireless communication network until receiving a wake-up confirmation from one of the central transceivers, wherein the transceiver is configured to step-wise increase a transmit power used for transmitting the wake-up signal.

In embodiments, the transceiver is configured to transmit a wake-up signal addressing one central transceiver out of a plurality of central transceivers of the wireless communication system, wherein the transceiver is configured to address the one central transceiver by adjusting at least one parameter of the wake-up signal associated with the one central transceiver.

In embodiments, the transceiver is served by a first central transceiver of the wireless communication network, wherein the transceiver is configured to transmit a wake-up signal to a second central transceiver of the wireless communication network, wherein the transceiver is configured to transmit, in response to a reception of a wake-up confirmation from the second central transceiver, a handover request to the first central transceiver requesting a handover from the first central transceiver to the second central transceiver.

In embodiments, the transceiver is served by a first central transceiver of the wireless communication network, wherein the transceiver is configured to detect a wake-up of a second central transceiver of the wireless communication network, wherein the transceiver is configured to transmit, in response to detecting that the second central transceiver has waken-up, a handover request to the first central transceiver requesting a handover from the first central transceiver to the second central transceiver.

In embodiments, the transceiver is served by a central transceiver of the wireless communication network, wherein the transceiver is configured to perform a communication with or via the central transceiver, wherein, in case that the communication is completed [e.g., traffic is done], the transceiver is configured to transmit a completion information to the central transceiver, the completion information signaling to the central transceiver that the communication is completed.

Further embodiments provide a central transceiver [e.g., gNB, cell, eNB, nB, base station, access point, relay node] of a wireless communication system, wherein the central transceiver is configured to switch from a low-power operating state into a normal operating state or partial low-power operating state in response to receiving a wake-up signal [e.g., transmit according to the control information].

Further embodiments provide a central transceiver [e.g., gNB, cell, eNB, nB, base station, access point, relay node] of a wireless communication system, wherein the central transceiver is configured to transmit a control information describing at least one out of
at least one parameter of a wake-up signal [e.g., to be used by a transceiver of the wireless communication network for waking-up the central transceiver or another central transceiver of the wireless communication network],
at least one low-power operating parameter of the central transceiver or of another central transceiver of the wireless communication network,
a list of one or more central transceivers that are in range of a transceiver of the wireless communication system [e.g., a list of one or more central transceivers serving the cell in which the transceiver is located and/or serving one or more neighboring cells].

In embodiments, the central transceiver is configured to switch from a low-power operating state into a normal operating state or partial low-power operating state in response to receiving a wake-up signal [e.g., transmit according to the control information].

In embodiments, the at least one low-power operating parameter of the central transceiver is
a low-power operating state or low-power operating states supported by the central transceiver,
a current low-power operating state of the central transceiver [e.g., dormant or awake],
a time-to-sleep indicator, or
a time-to-wakeup indicator.

In embodiments, the central transceiver is configured to receive a control information request requesting the transmission of the control information, wherein the central transceiver is configured to transmit the control information in response to the control information request.

In embodiments, the central transceiver is configured to transmit the control information in response to a successful authentication or logging in of the transceiver.

In embodiments, the central transceiver is configured to receive a predefined [e.g., standardized] wake-up signal.

In embodiments, the at least one parameter of the wake-up signal is
a transmission time or time slot of the wake-up signal,
a transmission frequency or channel of the wake-up signal,
a bandwidth of the wake-up signal,
a waveform type of the wake-up signal,
a time pattern of the wake-up signal,
a code of the wake-up signal,
a sequence of the wake-up, or
a content of the wake-up signal.

In embodiments, the central transceiver is configured to receive the wake-up signal on a predefined channel [e.g., standard rendezvous channel].

In embodiments, the central transceiver is configured to detect a signal that is transmitted using a predefined waveform [e.g., OOK, or based on a PN sequence or Zadoff-Chu sequence] as wake-up signal.

In embodiments, in case that the central transceiver is currently not serving a transceiver, the central transceiver is configured to switch from a normal SSB mode into a longer SSB mode and to switch back to the normal SSB mode in response to a reception of a wake-up signal.

In embodiments, the central transceiver comprises a dedicated wake-up receiver for receiving the wake-up signal.

In embodiments, the central transceiver is configured to switch off a transmission chain in the a low-power operating state.

In embodiments, the central transceiver is configured to increase the time between the transmission of beacons in the low-power operating state.

In embodiments, the central transceiver is configured to switch into the low-power operating state based on an absolute timing.

In embodiments, the central transceiver is configured to switch into the low-power operating state based on a relative timing.

In embodiments, the central transceiver is configured to switch from a low-power operating state into a partial low-power operating state in response to a reception of a first wake-up signal, wherein the central transceiver is configured to switch from the partial low-power operating state into the normal operating state in response to a reception of a second wake-up signal.

In embodiments, the central transceiver is configured to receive an information describing one or more other transceivers or central transceivers of the wireless communication network that are in a low-power operating state, wherein the central transceiver is configured to transmit a wake-up signal to at least one of the one or more other transceivers or central transceivers.

In embodiments, the central transceiver is configured to serve a transceiver of the wireless communication network, wherein the central transceiver is configured to perform a communication with the transceiver, wherein the central transceiver is configured to receive a completion information from the transceiver, the completion information signaling to the central transceiver that the communication is completed, wherein the central transceiver is configured to switch to a low-power state in response to the reception of the completion information.

Further embodiments provide a transceiver of a wireless communication network, wherein the transceiver is configured to repeatedly transmit a wake-up signal to one or more central transceivers of the wireless communication network until receiving a wake-up confirmation from one of the central transceivers, wherein the transceiver is configured to step-wise increase a transmit power used for transmitting the wake-up signal.

Further embodiments provide a transceiver of a wireless communication network, wherein the transceiver is configured to transmit a wake-up signal addressing one central transceiver out of a plurality of central transceivers of the wireless communication system, wherein the transceiver is configured to address the one central transceiver by adjusting at least one parameter of the wake-up signal associated with the one central transceiver.

In embodiments, the at least one parameter is
a transmission time of the wake-up signal,
a transmission frequency of the wake-up signal,
a code of the wake-up signal.

Further embodiments provide a transceiver of a wireless communication network, wherein the transceiver is served by a first central transceiver of the wireless communication network, wherein the transceiver is configured to transmit a wake-up signal to a second central transceiver of the wireless communication network, wherein the transceiver is configured to transmit, in response to a reception of a wake-up confirmation from the second central transceiver, a handover request to the first central transceiver requesting a handover from the first central transceiver to the second central transceiver.

Further embodiments provide a transceiver of a wireless communication network, wherein the transceiver is served by a first central transceiver of the wireless communication network, wherein the transceiver is configured to detect a wake-up of a second central transceiver of the wireless communication network, wherein the transceiver is configured to transmit, in response to detecting that the second central transceiver has waken-up, a handover request to the first central transceiver requesting a handover from the first central transceiver to the second central transceiver.

Further embodiments provide a central transceiver of a wireless communication network, wherein the central transceiver is configured to receive an information describing one or more other transceivers of the wireless communication network that are in a low-power operating state, wherein the first central transceiver is configured to transmit a wake-up signal to at least one of the one or more other transceivers.

Further embodiments provide a transceiver of a wireless communication network, wherein the transceiver is served by a central transceiver of the wireless communication network, wherein the transceiver is configured to perform a communication with or via the central transceiver, wherein, in case that the communication is completed [e.g., traffic is done], the transceiver is configured to transmit a completion information to the central transceiver, the completion information signaling to the central transceiver that the communication is completed.

Further embodiments provide a central transceiver of a wireless communication network, wherein the central transceiver is configured to serve a transceiver of the wireless communication network, wherein the central transceiver is configured to perform a communication with the transceiver, wherein the central transceiver is configured to receive a completion information from the transceiver, the completion information signaling to the central transceiver that the communication is completed, wherein the central transceiver is configured to switch to a low-power state in response to the reception of the completion information.

Further embodiments provide a transceiver of a wireless communication network, wherein the transceiver is configured to transmit a signal [e.g., a wake-up signal or control signal, or normal SSB mode request signal] to a central transceiver of the wireless communication network, wherein the signal is configured to control the central transceiver to switch from a longer SSB mode into a normal SSB mode, wherein the transceiver is configured to connect or handover to the central transceiver in response to a reception of a SSB from the central transceiver.

Further embodiments provide a central transceiver of a wireless communication network, wherein the central transceiver is configured to serve one or more transceivers of the wireless communication network, wherein, in case that the central transceiver is currently not serving a [e.g., any] transceiver, the central transceiver is configured to switch from a normal SSB mode into a longer SSB mode, wherein the central transceiver is configured to switch back to the normal SSB mode in response to a reception of a signal [e.g., wake-up signal from a transceiver of the wireless communication network.

In embodiments, a time interval between an immediately subsequent transmission of SSBs in the longer SSB mode is larger than a time interval between an immediately subsequent transmission of SSBs in the normal SSB mode.

Further embodiments provide a method for operating a transceiver [e.g., UE] of a wireless communication network. The method comprises a step of receiving a control information describing at least one out of
at least one parameter of a wake-up signal [e.g., to be used by the transceiver for waking-up a central transceiver of the wireless communication network that is in a low-power state [e.g., dormant state]],
at least one low-power operating parameter of a central transceiver [e.g., gNB, cell, eNB, nB, base station, access point, relay node] of the wireless communication network [e.g., serving a cell in which the transceiver is located or serving a neighboring cell],
a list of one or more central transceivers that are in range of the transceiver [e.g., a list of one or more central transceivers serving the cell in which the transceiver is located and/or serving one or more neighboring cells].

Further, the method comprises a step of transmitting, in dependence on the received control information, a wake-up signal [e.g., to a central transceiver of the wireless communication network that is currently in a low-power state [e.g., dormant state]].

Further embodiments provide a method for operating a transceiver of a wireless communication network. The method comprises a step of repeatedly transmitting a wake-up signal to one or more central transceivers of the wireless communication network until receiving a wake-up confirmation from one of the central transceivers. Further, the method comprises a step of step-wise increasing a transmit power used for transmitting the wake-up signal.

Further embodiments provide a method for operating a transceiver of a wireless communication network. The method comprises a step of transmitting a wake-up signal addressing one central transceiver out of a plurality of central transceivers of the wireless communication system. Further, the method comprises a step of addressing the one central transceiver by adjusting at least one parameter of the wake-up signal associated with the one central transceiver.

Further embodiments provide a method for operating a transceiver of a wireless communication network, wherein the transceiver is served by a first central transceiver of the wireless communication network. The method comprises a step of transmitting a wake-up signal to a second central transceiver of the wireless communication network. Further, the method comprises a step of transmitting, in response to a reception of a wake-up confirmation from the second central transceiver, a handover request to the first central transceiver requesting a handover from the first central transceiver to the second central transceiver.

Further embodiments provide a method for operating a transceiver of a wireless communication network, wherein the transceiver is served by a first central transceiver of the wireless communication network. The method comprises a step of detecting a wake-up of a second central transceiver of the wireless communication network. Further, the method comprises a step of transmitting, in response to detecting that the second central transceiver has waken-up, a handover request to the first central transceiver requesting a handover from the first central transceiver to the second central transceiver.

Further embodiments provide a method for operating a transceiver of a wireless communication network, wherein the transceiver is served by a central transceiver of the wireless communication network. The method comprises a step of performing a communication with or via the central transceiver. Further, the method comprises a step of transmitting, in case that the communication is completed [e.g., traffic is done], a completion information to the central transceiver, the completion information signaling to the central transceiver that the communication is completed.

Further embodiments provide a method for operating a central transceiver [e.g., gNB, cell, eNB, nB, base station, access point, relay node] of a wireless communication system. The method comprises a step of transmitting a control information describing at least one out of
at least one parameter of a wake-up signal [e.g., to be used by a transceiver of the wireless communication network for waking-up the central transceiver or another central transceiver of the wireless communication network],
at least one low-power operating parameter of the central transceiver or of another central transceiver of the wireless communication network,
a list of one or more central transceivers that are in range of a transceiver of the wireless communication system [e.g., a list of one or more central transceivers serving the cell in which the transceiver is located and/or serving one or more neighboring cells].

Further embodiments provide a method for operating a central transceiver of a wireless communication network. The method comprises a step of receiving an information describing one or more other transceivers of the wireless communication network that are in a low-power operating state. Further, the method comprises a step of transmitting a wake-up signal to at least one of the one or more other transceivers.

Further embodiments provide a method for operating a central transceiver of a wireless communication network. The method comprises a step of serving a transceiver of the wireless communication network. Further, the method comprises a step of performing a communication with the transceiver. Further, the method comprises a step of receiving a completion information from the transceiver, the completion information signaling to the central transceiver that the communication is completed. Further, the method comprises a step of switching to a low-power state in response to the reception of the completion information.

Further embodiments provide a method for operating a transceiver of a wireless communication network. The method comprises a step of transmitting a signal [e.g., wake-up signal] to a central transceiver of the wireless communication network, wherein the signal is configured to control the central transceiver to switch from a longer SSB mode into a normal SSB mode. Further, the method comprises a step of connecting to the central transceiver in response to a reception of a SSB from the central transceiver.

Further embodiments provide a method for operating a central transceiver of a wireless communication network. The method comprises a step of serving one or more transceivers of the wireless communication network. Further, the method comprises a step of switching, in case that the central transceiver is currently not serving a [e.g., any] transceiver, from a normal SSB mode into a longer SSB mode. Further, the method comprises a step of switching back to the normal SSB mode in response to a reception of a signal [e.g., wake-up signal] from a transceiver of the wireless communication network.

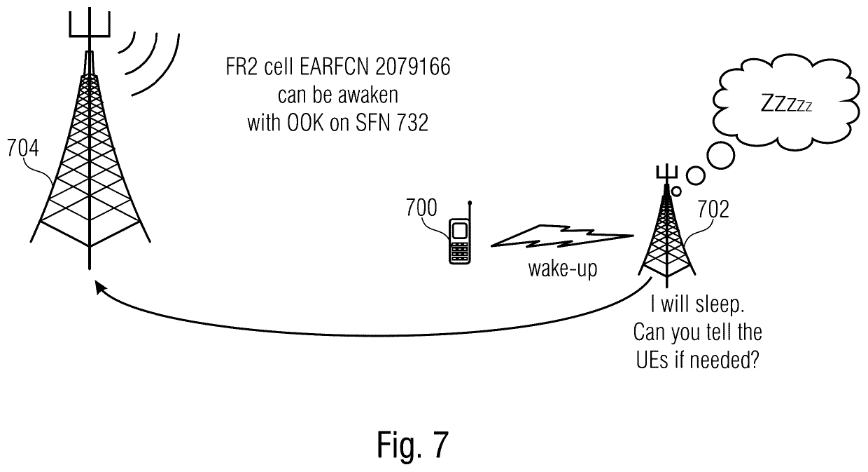

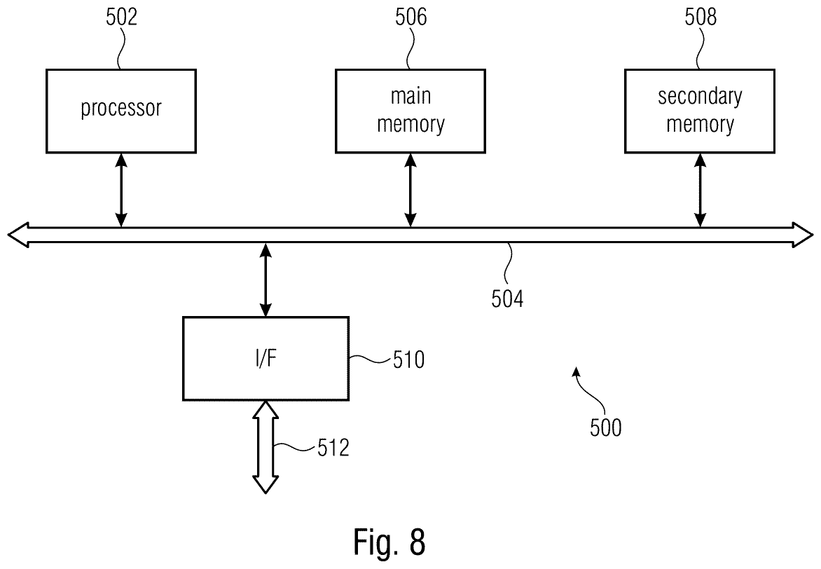

FIG. 7 shows an illustrative view of a method of informing a UE 700 about a central transceiver 702 that is in a dormant state and transmitting a wake-up signal to said central transceiver 702 from the UE 700. As shown in FIG. 7, when a cell 702 goes to a sleep mode, other cells 704 can be informed about that (e.g., via Xn or OAM). The remaining cells (e.g., macro layer) advertise information about the sleeping cell, including a description of a wake up signal (e.g., frequency, band, time, DRX cycle, waveform), rated capacity, special capabilities. The UE wakes up the appropriate sleeping cell. The UE sends a special handover request—with cause “I woke up my best serving cell”. If the UE is not active enough (e.g., no traffic during a certain inactivity timer), the cell may send back the UE to the old cell and sleep again.

Subsequently, embodiments of the present disclosure are described in further detail.

Thereby, herein the term gNB/cell is used generically to mean a wireless node at the infrastructure, which could be, for example, a gNB, eNB, nB, base station, access point, relay node, etc., as well of sub-parts of such gNB like a cell, Transmission Point (TRP), sector, antenna panel, antenna port, component carrier, subsystem etc. So, basically a gNB/cell is a part of wireless infrastructure which can be turned on and off. Similarly the term a User Equipment (UE) is used herein generically to describe a device of the user, e.g., smartphone, any kind of terminal (e.g. notepad, notebook), any kind of smart device (e.g. smart watch), communicating with other devices, e.g., via infrastructure or indirectly (e.g., via sidelink). This could be a UE, wireless terminal, Wifi Station, etc.

Embodiments relate to how to enable the possibility that the UE wakes up a wireless access node at the infrastructure with the transmission of a wake up signal. This signal may be received, for example, by a dedicated wake-up receiver at the gNB/cell or by the regular receiver of the gNB/cell configured to track a particular signal.

In embodiments, the elements to enable such over the air waking up of infrastructure are one or more of the following:
1. The gNB/cell needs to enter a dormant state which has certain specified characteristics, for example, that the gNB/cell can receive a certain wake-up signal, e.g., limited to a given schedule or certain points in time.
2. The UE needs to acquire knowledge about the existence of dormant gNB/cells in its vicinity.
3. The UE needs to acquire knowledge about the specific characteristics of the wake up signal.

Different variations of these three elements will lead to different embodiments and they are described in more detail in the following subsections.

Furthermore, to keep the timely re-activation of a gNB/cell regular state, embodiments provide some mobility procedures and some special signaling between UE and gNB/cell. This is also described in a separate section.

### 1. UE Knowledge Acquisition About Dormant gNB/Cells

In embodiments, the information about dormant gNB/cells can be simply about their existence, or contain some additional information, such as cell ID, geolocation, maximum supported data rate or feature capability or a neighbor cell list (e.g., transmitted by the gNB/cell), e.g., marking dormant cells or adding an extra list of neighbor cells, which are dormant, which assists the UE to determine that a suitable dormant gNB/cell is on the vicinity.

There are many different ways the UE can acquire information about dormant gNB/cells. Each following subsection specifies a possible way commenting on scenarios which this particular implementation may be favorable.

### 1.1. Autonomous UE Caching

Mobile devices, such as smartphones, spend a significant amount of time on advantageous locations, such as the user's home or user's workplace. In accordance with embodiments, over time the UE can create a caching database of information of gNBs and their cells which are often used. If the UE determines that it is on an advantageous location, e.g., via GNSS, positioning or measuring remaining cells, the UE may know the gNB/cell should be there even though the gNB/cell is currently not broadcasting any information.

In embodiments, this can be realized by a quite simple extension in the mobility procedures. During mobility each UE generates and maintains a list of suitable target cells by cell search and measurements. The UE just needs to transfer the detected cells into the cache and tag them with corresponding positioning information.

In addition to that the UE may request relevant cell information complementing the cell list with a newly defined request message. For example, to obtain the position of a cell.

### 1.2. Configuration App or Dialog

The use of autonomous UE caching (cf. section 1.1.) may lead to imperfections. For example, the gNB/cell present on the neighbor apartments may be added, even though it is not desired. In order to refine, or as main mechanism, in embodiments the user may be provided with a configuration app or configuration dialog where the user can confirm if a certain location is an advantageous location. Alternatively, in the configuration app/dialog could instead ask the user if a certain gNB/cell is an advantageous gNB/cell. If the user choses yes (e.g., that is an advantageous gNB/cell) the UE may later try to automatically wake up such gNB/cell.

### 1.3. Blind Guessing

In embodiments, if the wake up signal is standardized, and the gNB/cells are ready to receive such signal continuously (e.g., because they have a dedicated wake up receiver), the UE could simply send the wake up signal. In this case the discovery of dormant gNB/cells is a blind guessing (e.g., there may be a gNB/cell out there) and the signal would be equivalent to say “is there any gNB/cell out there?” This approach may be, for example, combined with the one on section 2.1. to have a very limited set of possibilities to be tried by the UE.

Blind guessing or blind WUS would allow for spare cells or repeaters that are normally dormant in area of bad coverage and are not integrated in the cell planning. Rather they can be used to enhance the coverage of a cell on demand. Consequently, they can have the same cell ID and synchronously behave like an additional TRP such that it appears to a UE transparently as the same cell.

### 1.4. Broadcast Information on Cell

In embodiments, when a gNB/cell is on regular operation, it may broadcast information indicating that it is a gNB/cell which may go into dormant state. This information may be cached by the UE.

Also, if the UE is still serving some UEs before the network decides the gNB/cell should go to sleep, the gNB/cell can inform the UEs it will sleep but that it will be available via a wake up signal. This could include for example a “time-to-sleep” indicator which the gNB/cell says in how many ms, s, min it will go to sleep. Another characteristic which can be broadcast is a “time-to-wakeup” which specifies how long the cell will take to be fully activated again when receiving a wake-up signal. In this way, different values of “time-to-wakeup” can be broadcast if the gNB/cell is going into different dormancy levels. Also, this could allow the UE to evaluate if the gNB/cell can serve it quickly enough.

One specific example of broadcasting per cell could be the use of neighbor cell, see section 1.7.

### 1.5. Broadcast Information on a Different Layer

Cellular networks are now mostly deployed as heterogeneous networks, where some layer, e.g., macro-layer provides basic coverage and mobility, whereas other layers, such as picocells and femtocells provide extra capacity. If a pico or femtocell is put into a dormant state, in accordance with embodiments it may send the information to the macrocell (e.g., via Xn or via OAM). The macrocell can then broadcast information about the dormant picocells or femtocells within its coverage. Alternatively, the UE could obtain this information via dedicated signaling to the macrocell.

### 1.6. Core Network/AS Server

In embodiments, the information about gNB/cells may be considered critical by the network, in terms of security, if, for example, geolocation of gNB/cells is included in the information. Or the service to wake up cells could be a service the operator would like to charge.

In those cases it could be more interesting to consider a solution where the information about dormant gNB/cells is stored in the core network or an application server and the information can be obtained by the UE communicating to the AMF via NAS signaling or to the AS via an application specific protocol, subject to the appropriate authorization, logging and charging.

### 1.7. Neighbor Cell List

In NR, the cell specific neighbor relationship are used, for example, for cell reselection, handover, blacklisting specifics cells or applying power offset, e.g., to bias cell re-selection in IDLE mode.

Diverse system information types (e.g., SIB3, SIB #4, SIB #5, SIB #24) may be used to broadcast the neighbor cells, e.g., the frequency ARFCNs, e.g., for inter frequency and I-RAT cell re-selection or for cell re-selection. The listed neighbor cells may apply to any kind of deployment, e.g., Stand Alone (SA) or Non Stand Alone (NSA) or any type of neighbor cell (e.g. LTE or NR).

Independent of the type of SIB broadcasting as well as of the type of neighbor cell (e.g., LTE or NR) or deployment, in accordance with embodiments, the neighbor cell list can be adapted to add (optionally) the information to each neighbor cell, whether it is (e.g., temporarily) dormant or (e.g., alternatively) awake.

Alternatively, in embodiments, in case the UEs receiving the list of neighbor cells from the gNB/cell without any indication about neighbor cell(s) being dormant or not, may try measuring any neighbor cells. In case no signal can be detected from neighbor cell(s) (e.g., once or over a given time period), the UE may consider these neighbor cell(s) as dormant cell(s).

In addition (or alternatively), in embodiments the UEs can send measurement report(s) (e.g., periodically or event driven) to the gNB/cell. Based on these measurement report(s), either due to excluding not measureable neighbor cells (e.g., no signal detected or indicating no measureable signal in the measurement report), the gNB/cell may be informed/updated on potentially sleeping neighbor cells. See section 6., how this information could be used to wake-up dormant gNB(s)/cell(s).

### 2. UE Knowledge Acquisition About Wake up Signals

In order for the UE to wake up the gNB/cell it needs not only to know that the dormant gNB/cell exists but also how it can be contacted, namely how to synthesize the wakeup signal.

In some embodiments, the UE may derive the wake-up signal waveform solely based on readily available, such as the cell ID (for example, using PSS or SSS).

In some embodiments the gNB/cell existence may be coupled with the wakeup signal information. For example, a gNB/cell before being dormant could broadcast information that it is susceptible to being dormant as well as a description of the wakeup signal when it is dormant.

In some embodiments the gNB/cell existence may be decoupled from the wakeup signal information. For example, the gNB/cell existence may be obtained from the core network subject to authorization and charging but the wake up signal description is broadcast by a macrocell and is valid for all or a subset of the picocells within this macrocell coverage.

The wakeup signal information may be, for example, at least one out of:
frequency/wireless channel (EARFCN, wifi channel),
bandwidth,
a waveform type,
time pattern when the gNB/cell receiver is ready to receive the wake up signal (e.g., absolute timing, relative timing, frame timing on other layer),
some ID of code or sequence, for example, physical cell ID or in case of Wifi BSS color,
beam information.

The following subsections describe different ways of obtaining such information.

### 2.1. Standard Rendezvous Channel

It would be really inefficient for a UE to send a generic wake up signal on very many different wireless channels. This could be the case, for example, if the UE does not know yet which channel/frequencies may have dormant gNB/cells. In order to address that issue, in embodiments, and most specifically on unlicensed bands a specific channel for rendezvous can be defined. Basically, the UEs would know they can send a signal on this channel and that would be equivalent to asking “is there any gNB/cell out there?”. The gNB/cells on vicinity can reply, for example, by sending a beacon. This beacon signal is special compared to regular beacon because it contains the actual channel where the gNB/cell really operates.

### 2.2. Single or Small Set of Wake up Signals

In order to completely avoid any signaling regarding the waveform, in embodiments, the wake-up signal(s) may be predefined, for example, on a standard.

If, for example, it is defined that gNB/cells are equipped with wake up receivers it can be also predefined what type of waveform is sent (e.g., OOK). In the case of a wake up receiver the timing pattern can be assumed as on. Alternatively, if the regular receiver is used and common sequences like Pseudonoise (PN) sequence or Zadoff-Chu (ZC), a small set of waveforms can be predefined as wake-up signal. Then the UE may try the different wake-up signals

### 2.3. Broadcast Information on Cell

One option for the description of wake up signal is that in regular operation the gNB/cell itself broadcasts information about the wakeup signal it will be receiving when it is dormant.

### 2.4. Broadcast Information on a Different Layer

As noted on section 1.5., in some deployments, such as heterogeneous networks, the information about dormant cells can be sent by the remaining gNB/cells. This may include the wake up signal description.

### 2.5. Core Network/AS

The information of wake up signals also can be stored and retrieved from core network or AS.

### 3. gNB/Cell Dormant States

A gNB/cell has many components and powering up or down these different components may take different times. Also in different wireless systems there can be different implications of gNB/cell dormancy. Therefore, in embodiments, the gNB/cell dormancy may take different forms. The following subsections highlight some important cases.

### 3.1. Extended Interval Between SSBs

The current 5G NR specifications define a SSB periodicity of up to 160 ms (TS 38.331):
“ssb-periodicityServingCell ENUMERATED {ms5, ms10, ms20, ms40, ms80, ms160, spare2, spare1} OPTIONAL,—Need S”

If a gNB/cell is not serving any user, in accordance with embodiments, larger intervals between SSBs can be defined so that the gNB/cell can go into a deeper sleep mode. As an implication, the mobility from users to that gNB/cell would be affected, as the UEs from neighbor cells will measure such cell less often. In order to overcome this limitation, in embodiments, a UE could send a wake up signal to restore the regular SSB interval of this dormant gNB/cell. Then the UE could measure the signal of the gNB/cell and if appropriate the handover can be executed. In this case this wake up signal could be, for example, based on a RACH preamble. In order to allow the gNB/cell to also disable the receiver, the RACH could be configured with a special long interval. Also a value of ssb-periodicityServingCell can be also an implicit indication that the UE needs to send a wake-up signal before accessing the dormant gNB/cell.

### 3.2. Complete Dormancy Based on Wake up Receiver

In embodiments, a dedicated wake up receiver can be implemented in a way which consumes much less power than a regular gNB/cell transceiver. In this case, nearly all elements of the gNB/cell can be turned off and only the dedicated wake up receiver is left on. This could be very favorable for deployments in remote locations (e.g., hard access), gNB/cells powered by renewable energy (like solar panels), or sparsely used.

### 3.3. Receiving Only gNB/Cells

In some systems, like 802.11, a preamble is sent on every transmission. This means that reception with the regular receiver can be done almost independent of sending broadcast information (e.g., beacons) or in general any transmission from gNB/cell. Thus, in accordance with embodiments, in such cases it is possible to have the normal operation of the gNB/cell to only having the reception chain on, and turning off the transmission chain. This can be combined with the standardized rendezvous channel described in section 2.1. to completely avoid sending beacons when no user is being served. This does not only improve energy efficiency, but also channel utilization as a large number of transmitted frames in unlicensed band are beacons, and they occupy the channel which can be used by other transmissions. If beacons are still needed for coarse synchronization they can be sent more sparsely.

### 3.4. Receiving On/Off Pattern Based on Absolute Timing

As discussed in the introductory section, turning off the transceiver and turning on periodically is an essential power saving feature on UE side (DRX). Essential to DRX operation is the existence of a common time reference for the transmitting side and receiving side, such that a duty-cycle can be defined. When a UE does DRX, this common reference is the frame number on the serving cell. But when the gNB/cell itself is turned off, the questions arises as what shall be the timing reference. This section discusses a solution based on absolute timing and the next one based on relative timing.

Many systems nowadays can receive time synchronization, such as precision time protocol (PTP) and generic precision time protocol (gPTP). While there should be some tolerance of time offsets, in accordance with embodiments, longer time patterns can be defined where the gNB/cell receiver is on or off, so that the gNB/cell can save not only transmit power, but also power on the reception circuitry. This can be, for example, a rule that the receiver is turned on during a first part of a time span, for example, the first 5 seconds of a minute, and turned off during a second part of said time span, for example, in the remaining 55 seconds.

In embodiments, the time pattern can be further enhanced by defining the type of sleep mode of the cell, e.g., deep sleep mode where TX/RX units are completely switched off or any further dormant state as defined in the subsection 3.5. Per type of dormant state, separate time patterns could be defined.

### 3.5. Receiving On/Off Pattern Based on Relative Timing

As discussed in the previous section, in order to enable a receiver to be off for some time, also the transmitting side needs to know the on/off pattern.

In some situations there may be a different reference timing that can be used by the dormant gNB/cell and the UE to define an on/off pattern of the receiver (gNB/cell). As an example, for picocells attached to a macro gNB/cell the on/off pattern can be defined based on the frame number of the macro (SFN). The UE can obtain the on/off pattern from the macro gNB/cell or like for UE DRX to calculate based on a formula. In this case, the formula can be based on the physical cell ID or cell identity of the dormant gNB/cell.

The same enhancements, i.e. considering the type of dormant state (see section 3.4.), can also apply here.

### 3.6. Multiple Dormancy Levels

In the example of a hiking trail (cf. section 7.3), there is a big difference between a user getting nearby the infrastructure and using it for a demanding service (e.g., an extended reality live). In such cases, in accordance with embodiments, multiple dormancy levels can be defined. For example, the gNB/cell may be fully dormant if there is no UE nearby. Once a UE approaches it, it sends a first wake-up signal to make the gNB/cell to work on a partial dormancy (e.g., restricted operation), where the gNB/cell can have basic operation but it still can save significant power. Finally, once the demanding service starts, a second wake-up signal can be sent to bring the gNB/cell from partial dormancy to normal operation.

Alternatively, in this case it also can be possible that the second wake-up signal instead of being a physical layer signal (e.g., waveform) to be some higher layer protocol signaling.

### 4. Selectively Waking up Cells

The wireless medium is inherently broadcast. This means that if a UE sends a wake up signal it may wake up more than one gNB/cell, which may be the undesired behavior. Some alternatives are described below.

### 4.1. Waking up the Closest Cell

The idea of waking up a cell is in order for the UE to change to a new best serving cell. This can be discovered by the UE applying a power ramp up procedure to the wake up signal. The UE starts with PMIN and increases the power in steps of AP power up to the maximum power PMAX. After each step, the UE awaits for a certain time the confirmation if a cell has been awaken, which can be, for example, a beacon or SSB. Only if no cell has been awaken the UE proceeds to the next power.

Typically, with this procedure only the cell with best coverage should be awaken. But if accidentally two or more cells are awaken the cell could go to sleep again if no RACH is received within a specified time.

It could also be beneficial to define situations where this procedure is skipped. For example, in the accident scenario of section 7.1., an emergency wake up signal can be sent immediately with maximum transmit power.

### 4.2. Unicast and Groupcast Wakeup

In order to avoid waking up cells which should not need to be awaken, subgroups of cells can be defined. In essence that boils down to defining one or more multiple access dimension (e.g., time, frequency, space, code) and making sure that in different cells the receiver of dormant cells is configured to match the corresponding wake up signal.

As one example, if the on/off patterns of section 3.4. or 3.5. are used, different patterns can be assigned to different dormant gNB/cells. That corresponds to multiple access on time to domain. Similarly, if more than one rendezvous channel is used (see section 2.1.), gNB/cells can be distributed to different frequency channels corresponding to multiple access on frequency domain.

On space domain, beam information can be provided such that the wake-up signal is beamformed towards the dormant cell, to avoid it spreading to other cells (e.g., and waking them up unintentionally).

Finally, on code domain, some existing code such as the physical cell ID can be used to define different signals and in this case as long as the code is not repeated too often the UE may be able to wake up a single gNB/cell by coding the signal with that ID.

### 5. Pre and Post Wake up Signal Communication

Once a gNB/cell restores regular operation, a possibility is simply to rely on existing mechanisms for mobility, in which the network can reconfigure the UE with a new measurement object including the cell which was just awaken. The UE can start to measure, and after the condition is matched the handover can be initiated. However, relying on such mechanisms can lead to very significant delays in making the infrastructure available. This is exactly embodiments improve. Specifically, according to embodiments, a cell is turned on more quickly such that surges on traffic can be served and the demands of critical traffic can be matched (see, e.g., section 7.1.).

Therefore, according to embodiments, new signaling mechanisms are used to cope with this situation of dormant cell being awaken by the UE.

In embodiments, as soon as the UE knows the new cell is awaken, it can signal to the serving gNB/cell a handover request to the awaken cell with a cause which indicates that this was a cell awaken by this UE (e.g., cause “cell wake-up”). This can be considered by the network to make a faster handover and perhaps consider less stringent requirements on the handover decision. The decision would still be done by the network but that decision would be taken more quickly than relying on existing mechanisms (e.g., measurement object reconfiguration, measurement triggering and reporting).

Another alternative is to have a predefined measurement event applicable to cells which were just awaken. Then the UE can go directly to reporting the event instead of needing to wait the reconfiguration of measurements. This cuts down the setup latency significantly.

If the awaken gNB/cell restores the Xn interface to the serving cell, it also can be possible to receive system information from the awaken cell via the serving cell to make a faster setup.

Further, for the benefit of the network, the UE which has awaken a cell also can inform the network when it is done (e.g., the high demanding special traffic is done). Thus, the network can put the gNB/cell back to sleep more quickly.

### 6. Neighbor Cell Transmitting Wake-up Signal to Dormant Cell

Beside the UE sending a wake-up signal, also another cell (e.g., another sector cell of the same BS, a neighbor cell, a macro cell) can send a wake-up information to a dormant cell, e.g., via Xn interface.

For example, as described in section 1.7, a cell may derive form measurement reports received from the UE, the information about dormant cells. In case of increasing traffic, the serving cell receiving the measurement report may wake-up dormant neighbor cells.

### 7. Implementation Examples

Subsequently, implementation examples of embodiments of the present disclosure are described.

### 7.1. Car Accident During the Night

The traffic in cellular networks is typically much lower during the night than during day hours. A state-of-art network energy management system will most certainly de-activated significant parts of the wireless infrastructure during those hours. The management system however cannot predict when an accident will happen during night hours. Therefore it can only operate reactively to the sudden new demand of traffic. This reaction may take long and may not provide the needed full response immediately. Some increased traffic on the macro layer of this area may trigger some network restoring or not depending on thresholds. If gNB/cells should be awaken, the questions arises as to which ones should be awaken. These are complicated questions which would make the re-activation time of the network quite long. All of this costs precious time which could cost also lives.

In contrast, according to embodiments of the present disclosure, an emergency system on the accidented cars or devices from the users involved in the accident can send an emergency wake up signal which restores the maximum network capability immediately. These systems then can automatically send, for example, high quality video from the accident site to the firefighters, send vital signals of the involved people, and other important sensor information. When the emergency team comes to the site, the whole infrastructure is ready, even for high demanding services like remote surgery.

### 7.2. Valet Parking

In a valet parking, e.g., in a multi-story car park, a very dense and high demand infrastructure may be set to allow autonomous parking. But the need of such infrastructure is highly variable. At some peak hours (e.g., start of working day) there can be a lot of cars but at other times there can be several minutes between two cars accessing the parking lot.

When a car arrives to the parking lot, the driver turns on the key or remotely request that the car comes to him/her then the car can use embodiments of the present disclosure to wake up the needed infrastructure. There is also no need to wake up all cells on the multi-story building. The cells can be awaken as the car comes nearby and turned off right after. Even if the valet-parking would like to control the route of the car, in which case waking up gNB/cells could be done in a centralized way efficiently, it would still be beneficial to apply wake-up signal to the first gNB/cell on the route (e.g., covering parking entrance or place where the car is parked).

### 7.3. Scarcely Used Infrastructure

Similar to the valet parking case even during day in large parks, hiking trails, forests, etc. it can be that there are several minutes or even hours between the events of two users coming by along the same path. Also this demand vary a lot with events which a centralized system cannot take into account (e.g., a group hiking). Such places would benefit with cellular coverage, or even a high capacity pico-layer, but the power consumption should be absolute minimal such that the OPEX of the infrastructure is low enough for the investment to make sense (e.g., power supply is battery+solar panel).

In such locations there would be a high benefit of embodiments of the present disclosure such that when a user is near the gNB/cell, the gNB/cell can be readily used but otherwise it can stay dormant most of the time.

### 7.4. Regular Operation and Future Mobile Communication Generations

The previous subsections describe cases where a large benefit comes from waking up cells timely. But in addition to that if cells are awaken quickly and timely, they can also be put to sleep more often without affecting the network capacity and perceived quality of end-user experience. Thus, embodiments of the present disclosure can also benefit regular operation of the network even during high traffic demand.

Ultimately, embodiments of the present disclosure present a foundation which can be used for a new design (e.g., in 6G), where the design principle is that most of the infrastructure is turned off most of the time and the UEs need to wake-up the cells to use the service.

### 8. Further Embodiments

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present disclosure may be implemented in hardware using analog and/or digital circuits, in software, through the execution of instructions by one or more general purpose or special-purpose processors, or as a combination of hardware and software. For example, embodiments of the present disclosure may be implemented in the environment of a computer system or another processing system. FIG. 7 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present disclosure. In particular, the computer program, when executed, enables processor 502 to implement the processes of the present disclosure, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the disclosure comprise a data carrier having electronically readable control signals, which are capable of cooperating with a programmable computer system, such that one of the methods described herein is performed.

Generally, embodiments of the present disclosure may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this disclosure has been described in terms of several advantageous embodiments, there are alterations, permutations, and equivalents, which fall within the scope of this disclosure. It should also be noted that there are many alternative ways of implementing the methods and compositions of the present disclosure. It is therefore intended that the following appended claims be interpreted as including all such alterations, permutations, and equivalents as fall within the true spirit and scope of the present disclosure.

### ABBREVIATIONS

3GPP third generation partnership project
5QI 5G QoS identifier
AAIM aircraft autonomous integrity monitoring
AL alert limit
AMF access and mobility management function
ARAIM advanced receiver autonomous integrity monitoring
BS base station
BWP bandwidth part
CBG code block group
CQI channel quality indicator
CSI-RS channel state information-reference signal
D2D device-to-device
DAI downlink assignment index
DCI downlink control information
DL downlink
DRX discontinuous reception
FFT fast Fourier transform
gNB next generation node B-base station
GNSS global navigation satellite system
HARQ hybrid automatic repeat request
IE information element
IoT internet of things
ITS intelligent transportation systems
LTE long term evolution
MAC medium access control
MCR minimum communication range
MCS modulation and coding scheme
MIB master information block
MMC mobile country code
MNC mobile network code
NACK negative acknowledgement
NB node B
NR new radio, 5G
NTN non-terrestrial network
NW network
OFDM orthogonal frequency-division multiplexing
OPEX operational expenditures
OFDMA orthogonal frequency-division multiple access
PBCH physical broadcast channel
PC5 sidelink interface
PDCCH physical downlink control channel
PDSCH physical downlink shared channel
PL protection level
PLMN public land mobile network
PPP point-to-point protocol
PRACH physical random access channel
PRB physical resource block
PRS public regulated services (Gallileo)
PSCCH physical sidelink control channel
PSFCH physical sidelink feedback channel
PUCCH physical uplink control channel
P-UE pedestrian UE, in embodiments not limited to pedestrians, but represents any UE with a need to save power, e.g., electrical cars, cyclists, etc.
PUSCH physical uplink shared channel
QoS quality of service
RAIM receiver autonomous integrity monitoring
RAN radio access networks
RAT radio access technology
RNTI radio network temporary identifier
RS reference symbols/signal
RSRP reference signal received power
RSRQ reference signal received quality
RTK real time kinematics
RTT round trip time
SBAS space-based augmentation systems
SBI service based interface
SCI sidelink control information
SDL supplementary downlink
SI system information
SIB system information block
SINR signal-to-interference ratio
SL sidelink
SSB synchronization signal/PBCH block
SSR state space representation
SUL supplementary uplink
TDD time division duplex
TDOA time difference of arrival
TIR target integrity risk
TRP transmission reception point
TTA time-to-alert
TTI transmission time interval
UAV unmanned aerial vehicle
UCI uplink control information
UE user equipment
UL uplink
UMTS universal mobile telecommunication system
V2V vehicle-to-vehicle
V2X vehicle-to-everything
VRB virtual resource block
VRU vulnerable road user
V-UE vehicular UE
WiFI a family of wireless network protocols, based on the IEEE 802.11 family of standards,
WLAN wireless local area network
OPEX operating expenses
Xn an interface between base stations
OAM operations administration and maintenance

1. A transceiver for a wireless communication system,
wherein the transceiver is configured to receive a control information describing
at least one parameter of a wake-up signal, and
at least one low-power operating parameter of a central transceiver of the wireless communication system,
wherein the transceiver is configured to transmit, depending on the received control information, a wake-up signal to restore a regular Synchronization Signal Block (SSB) interval of the central transceiver.

2. The transceiver according to claim 1,
wherein the at least one low-power operating parameter of the central transceiver is
a low-power operating state or low-power operating states supported by the central transceiver,
a current low-power operating state of the central transceiver,
a time-to-sleep indicator, or
a time-to-wakeup indicator,
or wherein the transceiver is configured to receive the control information from
a central transceiver serving a cell in which the transceiver is currently located,
a central transceiver currently serving the transceiver,
another central transceiver,
the wireless communication system.

3. (canceled)

4. The transceiver according to claim 1,
wherein the transceiver is configured to transmit a control information request requesting a transmission of the control information, wherein the transceiver is configured to receive the control information that is transmitted in response to the control information request,
or wherein the transceiver is configured to authenticate itself to a network entity or to log in into the network entity, wherein the wherein the transceiver is configured to receive the control information in response to the successful authentication or logging in.

5. (canceled)

6. The transceiver according to claim 1,
wherein the transceiver is configured to generate or maintain a data base having stored a list of central transceivers together with an information describing a position or area served by each of the central transceivers,
wherein the transceiver is configured to select, depending on a current position of the transceiver, one of the central transceivers and to transmit a wake-up signal to the selected central transceiver.

7. The transceiver according to claim 6,
wherein the transceiver is configured to update the database depending on an user input.

8. The transceiver according to claim 1,
wherein the control information describes the at least one low-power operating parameter of the central transceiver,
wherein the transceiver is configured to transmit a predefined wake-up signal.

9. The transceiver according to claim 1,
wherein the at least one parameter of the wake-up signal comprises
a transmission time or time slot of the wake-up signal,
a transmission frequency or channel of the wake-up signal,
a bandwidth of the wake-up signal,
a waveform type of the wake-up signal,
a time pattern of the wake-up signal,
a code of the wake-up signal,
a sequence of the wake-up, or
a content of the wake-up signal.

10. The transceiver according to claim 9,
wherein the at least one parameter of the wake-up signal is transmitted by
a central transceiver serving a cell in which the transceiver is currently located,
a central transceiver currently serving the transceiver,
another central transceiver,
the wireless communication system.

11. The transceiver according to claim 1,
wherein the transceiver is configured to transmit the wake-up signal on a predefined channel,
or wherein the transceiver is configured to transmit the wake-up signal using a predefined waveform,
or wherein the transceiver is configured to transmit a first wake-up signal to a central transceiver, in order to control the central transceiver to switch from a low-power operating state into a partial low-power operating state, wherein the transceiver is configured to transmit a second wake-up signal to the central transceiver, in order to control the central transceiver to switch from the partial low-power operating state into the normal operating state.

12-13. (canceled)

14. A central transceiver of a wireless communication system,
wherein the central transceiver is configured to transmit a control information describing
at least one parameter of a wake-up signal, and
at least one low-power operating parameter of the central transceiver or of another central transceiver of the wireless communication network,
wherein the central transceiver is configured to restore a regular Synchronization Signal Block (SSB) interval in response to receiving the wake-up signal.

15. The central transceiver according to claim 14,
wherein the central transceiver is configured to switch from a low-power operating state into a normal operating state or partial low-power operating state in response to receiving a wake-up signal,
or wherein the at least one low-power operating parameter of the central transceiver comprises
a low-power operating state or low-power operating states supported by the central transceiver,
a current low-power operating state of the central transceiver,
a time-to-sleep indicator, or
a time-to-wakeup indicator.

16. (canceled)

17. The central transceiver according to claim 14,
wherein the central transceiver is configured to receive a control information request requesting a transmission of the control information, wherein the central transceiver is configured to transmit the control information in response to the control information request,
or wherein the central transceiver is configured to transmit the control information in response to a successful authentication or logging in of the transceiver,
or wherein the control information describes the at least one low-power operating parameter of the central transceiver, wherein the central transceiver is configured to receive a predefined wake-up signal.

18-19. (canceled)

20. The central transceiver according to claim 14,
wherein the at least one parameter of the wake-up signal is
a transmission time or time slot of the wake-up signal,
a transmission frequency or channel of the wake-up signal,
a bandwidth of the wake-up signal,
a waveform type of the wake-up signal,
a time pattern of the wake-up signal,
a code of the wake-up signal,
a sequence of the wake-up, or
a content of the wake-up signal.

21. The central transceiver according to claim 14,
wherein the central transceiver is configured to receive the wake-up signal on a predefined channel,
or wherein the central transceiver is configured to detect a signal that is transmitted using a predefined waveform as wake-up signal,
or wherein, in case that the central transceiver is currently not serving a transceiver, the central transceiver is configured to switch from a normal SSB mode into a longer SSB mode and to switch back to the normal SSB mode in response to a reception of a wake-up signal,
or wherein the central transceiver comprises a dedicated wake-up receiver for receiving the wake-up signal.

22-24. (canceled)

25. The central transceiver according to claim 14,
wherein the central transceiver is configured to switch off a transmission chain in a low-power operating state,
or wherein the central transceiver is configured to increase the time between a transmission of beacons in a low-power operating state,
or wherein the central transceiver is configured to switch into a low-power operating state based on an absolute timing,
or wherein the central transceiver is configured to switch into a low-power operating state based on a relative timing.

26-28. (canceled)

29. The central transceiver according to claim 14,
wherein the central transceiver is configured to switch from a low-power operating state into a partial low-power operating state in response to a reception of a first wake-up signal,
wherein the central transceiver is configured to switch from a partial low-power operating state into a normal operating state in response to a reception of a second wake-up signal.

30. A method for operating a transceiver of a wireless communication network, wherein the method comprises:
receiving a control information describing
at least one parameter of a wake-up signal, and
at least one low-power operating parameter of a central transceiver of the wireless communication network,
transmitting, in dependence on the received control information, a wake-up signal to restore a regular Synchronization Signal Block (SSB) interval of the central transceiver.

31. A method for operating a central transceiver of a wireless communication system, the method comprising:
transmitting a control information describing
at least one parameter of a wake-up signal, and
at least one low-power operating parameter of the central transceiver or of another central transceiver of the wireless communication network; and
restoring a regular Synchronization Signal Block (SSB) interval in response to receiving the wake-up signal.

32. A non-transitory digital storage medium having a computer program stored thereon to perform the method for operating a transceiver of a wireless communication network, wherein the method comprises:
receiving a control information describing
at least one parameter of a wake-up signal, and
at least one low-power operating parameter of a central transceiver of the wireless communication network; and
transmitting, in dependence on the received control information, a wake-up signal to restore a regular Synchronization Signal Block (SSB) interval of the central transceiver,
when said computer program is run by a computer.

33. A non-transitory digital storage medium having a computer program stored thereon to perform the method for operating a central transceiver of a wireless communication system, the method comprising:
transmitting a control information describing
at least one parameter of a wake-up signal, and
at least one low-power operating parameter of the central transceiver or of another central transceiver of the wireless communication network; and
restoring a regular Synchronization Signal Block (SSB) interval in response to receiving the wake-up signal,
when said computer program is run by a computer.
